(19) United States
(12) Patent Application Publication
(10) Pub. No.: US 2026/0255040 A1
(43) Pub. Date: Aug. 27, 2026

(54) TILEABLE IMAGE SENSOR ARRAY

(71) Applicant: U.S. Army DEVCOM, Army Research Laboratory, Adelphi, MD (US)

(72) Inventors: Patrick W. Jungwirth, Abingdon, MD (US); W. Michael Crowe, Madison, AL (US)

(73) Assignee: U.S. Government, as Represented by the Secretary of the Army, Adelphi, MD (US)

(21) Appl. No.: 19/064,226

(22) Filed: Feb. 26, 2025

(51) Int. Cl. H04N 23/55; H04N 23/16; H04N 23/81

(52) U.S. Cl. CPC H04N 23/55; H04N 23/16; H04N 23/81

(57) ABSTRACT

A tileable, low-cost image sensor array suitable for creating very large images (e.g., >1 gigapixel). The optical system can also be used to combine low resolution displays to create very high-resolution images (e.g., >1 gigapixel). It includes at least one beam splitter, a pair of sensor arrays and a mirroring means (physical mirror or electronic/digital mirroring algorithm). With 10 megapixel image sensors, four arrays 6×6 image sensors would provide a gigapixel image. For 48 megapixel image sensors, four array of 3×3 image sensors would provide a gigapixel image. The design of the image sensor arrays, when factoring in mirroring of the image array sensors, allows for the images to be stitched together to form a composite image.

### GOVERNMENT INTEREST

The invention described herein may be manufactured, used and licensed by or for the U.S. Government.

### BACKGROUND OF THE INVENTION

### Field

Embodiments of the present invention are directed to image sensors and, more particularly, to a tileable image sensor array.

### Description of Related Art

Image sensors having a very large number of pixels are increasingly in demand for imaging. The very large number of pixels provide greater image resolution and larger imaging capability. However, the costs to manufacture large image sensors, for instance, more than 1 gigapixels, are costly due to defects which reduce the quality of the sensor. Significant defects are rejected in Quality Assurance (QA/) Quality Control (QC) processes in the sensor production line. The greater number of pixels per sensor increases the risk of defects.

In light of the foregoing, improvements for image sensors are desired.

### SUMMARY

We introduce a low-cost tileable image sensor array using low-cost optical components, and low cost (non-higher precision) assembly methods. It includes at least one beam splitter, a pair of sensor arrays and a mirroring means (physical mirror or electronic/digital mirroring algorithm). The image sensor forms a unique optical path to create various image planes to allow arrays of image sensors to completely cover the image plane when factoring in the mirroring means. There may be a slight overlap in sensor area which provides for sub-image position calibration, sub-image intensity calibration, sub-image color calibration and optical alignment calibration. An image stitching technique may be used to combine the image tiles to form a large composite image which can be 1 gigapixel resolution (or much resolution).

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments, including less effective but also less expensive embodiments which for some applications may be preferred when funds are limited. These embodiments are intended to be included within the following description and protected by the accompanying claims.

FIG. 1 presents a 2-dimensional view of a single beam splitter embodiment of the present invention.

FIG. 2 shows a 3-dimensional view of a single beam splitter embodiment of the present invention.

FIG. 3 shows a basic embodiment of a single beam splitter version of the present invention.

FIG. 4 shows mirroring images.

FIG. 5 illustrates using a mirror to correct mirror image generated by beam 2 of the present invention.

FIG. 6 shows a digital method to correct for the mirrored image generated by beam 2from FIG. 5.

FIG. 7 illustrates the image sensor tiles used for sensor array 1 (FOV-1) and sensor array 2 (FOV-2) of the present invention.

FIG. 8 presents a 3-dimensional view of sensor array 1 and sensor array 2 according to an embodiment of the present invention.

FIG. 9 highlights the image tile positions and spaces between image tiles according to an embodiment of the present invention.

FIG. 10 shows the dimensions and spacings for the image sensor tiles to create a composite image.

FIG. 11 illustrates combining sensor array data to create a composite image.

FIG. 12 illustrates creating a composite image from sensor array data.

FIG. 13 sets forth the image processing steps for the single beam splitter embodiment of the present invention.

FIG. 14 presents a 2-dimensional view of the present 3-beam splitter embodiment. There are 4 image planes to create the 4 sensor tile arrays.

FIG. 15 presents a 3-dimensional view of FIG. 14.

FIG. 16 shows the image sensor tile arrays.

FIG. 17 illustrates an example sensor tile array for the 4 image planes.

FIG. 18 shows how the 4 overlapping sensor tile arrays can be combined to create a composite image without any missing image areas.

FIG. 19 shows how the embodiments of the present invention can be applied to hyperspectral imaging.

FIG. 20 shows an example optical assembly according to embodiments of the present invention.

FIG. 21 shows the anti-reflection coatings and optical baffles according to embodiments of the present invention.

FIG. 22 shows the anti-reflection coatings and optical baffles for the image tile arrays.

FIG. 23 describes the optical calibration data sets according to embodiments of the present invention.

FIG. 24 presents a block diagram showing the steps to create a composite image.

FIG. 25 provides an example of converting the image tiles to a composite image.

FIG. 26 summarizes the algorithm to create a composite image according to embodiments of the present invention.

### DETAILED DESCRIPTION

The present invention is a low cost, extendable, image sensor array. It includes at least one beam splitter, a pair of sensor arrays and a mirroring means (physical mirror or electronic/ digital mirroring algorithm). The image sensor forms a unique optical path to create various image planes to allow arrays of image sensors to cover the image plane when factoring in the mirroring means. Ideally, full coverage is sought. The optical system can also be used to combine low resolution displays to create very high-resolution images (e.g., >1 gigapixel). With 10 megapixel image sensors, four arrays of 6×6 image sensors would provide a gigapixel image. For 48 megapixel image sensors, four arrays of 3×3 image sensors would provide a 1.3 gigapixel image. A slight overlap (e.g., up to 20%) of tileable image sensors array allows for the images to be stitched together. This sensor technology may be beneficial to areal mapping, surveillance systems, imaging satellites, missile seekers, and medical imaging. It may also apply to light optical field cameras.

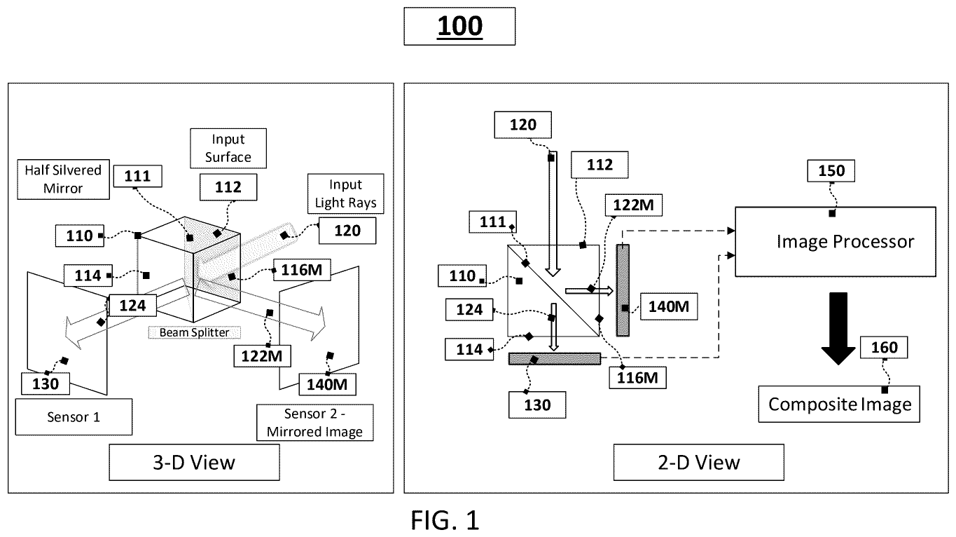

FIG. 1 shows an overview, including three-dimensional (3D) and two-dimensional (2D) views, respectively, of a tileable array image sensor 100 in accordance with embodiments herein. This sensor 100 is considered one-dimensional as it just affects tiling in one direction, for instance, horizontally or vertically. It includes a beam splitter 110 along with two sensors array, Sensor 1 130 and Sensor 2 140M.

Light rays 120 enter the beam splitter 110 at the input surface 112. Additionally, focusing options, such as a lens(es), filter(s) and/or collimator(s), may be provided to shape the light rays 120 before they enter the beam splitter 110. The beam splitter 110 is an optical device which includes an internal partially-reflective, half-silvered mirror 111, position at a 45° angle, that splits a beam of light into a reflected beam 112M and transmitted beam 124. Approximately half the entering light rays 120 is reflected by the mirror 111 as reflected beam 112M which exits from surface 116M of the beam splitter 110. The other half of the entering light rays 120 passes through the mirror 111 as transmitted beam 124 which exits from surface 114 of the beam splitter 110. Due to the mirror 111 of the beam splitter 110 reflecting light, the reflected beam 112M will be a mirrored image of the transmitted light.

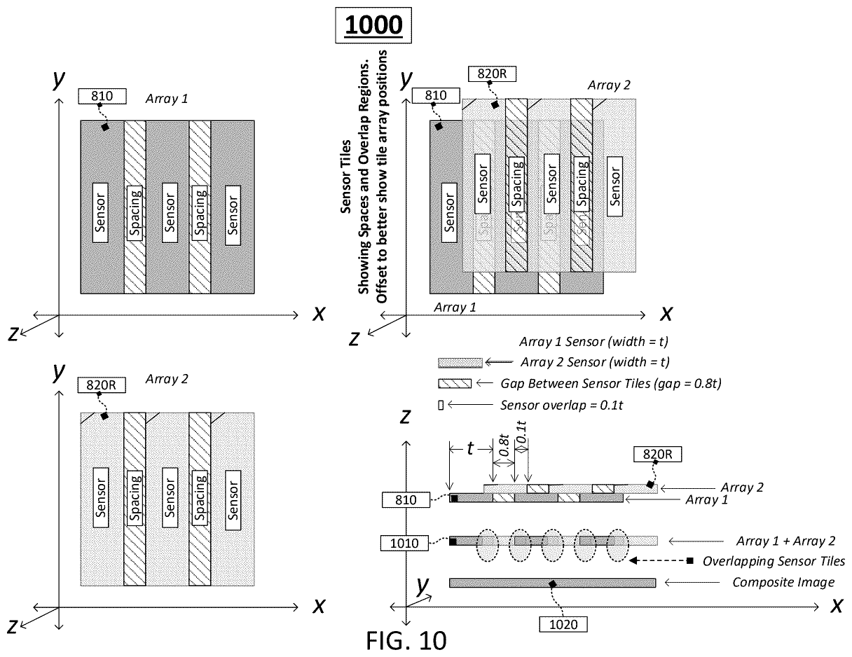

We place image sensors, Sensor 1 130 and Sensor 2 140M, at the Fields of Views (FOVs) or image planes for the transmitted rays 124 and the reflected rays 122M, respectively, exiting the beam splitter 110. Image Sensors 130 and 140M each are constructed as an image sensor array. That is, they are formed of multiple image sensors. (see FIG. 10). In the image sensor arrays, the image sensors are spaced-apart in a first direction having a first field of view positioned near the first surface of the first beam splitter, to receive the transmitted light from the beam splitter. The individual image sensors (of the image sensor arrays) may be charged coupled devices (CCD) or other image capturing sensors. They can be used to capture and output grayscale, monochrome and/or color pixel data for images. The resolution of images generated by each image sensor could be about 1-50 megapixels or larger, for example. The pixel data may be 1-D or 2-D depending on the image sensor, although, we note that 2D pixel data provides greater use for more applications. We use the terms “tile” and “tiles” herein to refer to the images capture by the individual image sensor of the image array sensors.

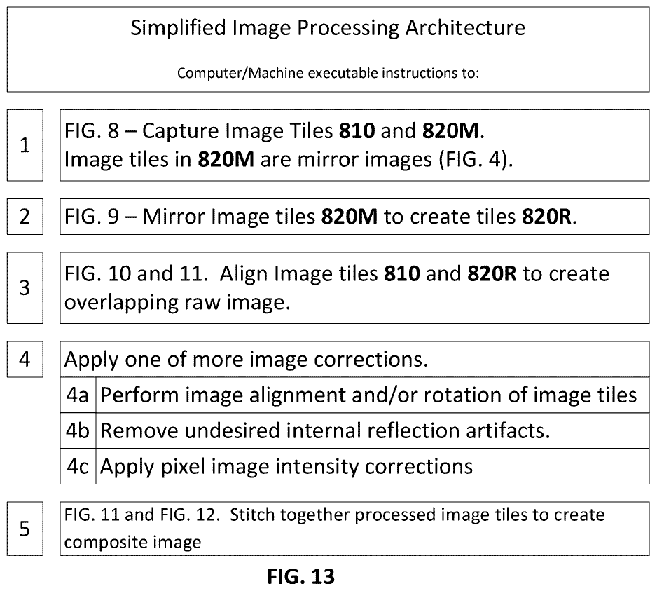

The images from images sensors 130 and 140M are fed to an image processor 150, which processes the imagery to generate a composite image 160. The image processor 150 is configured to: obtain first and second sets of images from the first and second image sensor arrays, respectively; align and superimpose the first set of images and the second set of images factoring in the effect of the mirror means; and combine the aligned superimposed images to generate a composite image. The latter processing step may involve an image stitching technique. We describe the specific processing performed by the image processor 150 in greater detail later (see, e.g., FIG. 13).

The processor 150 may be one or more of, or combinations thereof, microprocessors, microcontrollers, field-programmable gate arrays (FPGAs), application specific integrated circuits (ASICs), and/or the like, which are configured to execute machine-or computer-readable instruction (code), stored in non-transitory memory, to implement image processing in accordance with embodiments herein. The methods and algorithm disclosed herein may be implemented and executed by an application created using any number of programming routines. Of course, any number of hardware implementations, programming languages, and operating platforms may be used without departing from the spirit or scope of the invention. As such, the description or recitation of any specific hardware implementation, programming language, and operating platform herein is exemplary only and should not be viewed as limiting.

The composite image 160 that is generated may be any digital image file generally used for still images or videos (multi-image frames), such as JPEG (Joint Photographic Experts Group), PNG (Portable Network Graphics), GIF (Graphics Interchange Format), TIFF (Tag Image File Format), and BMP (Windows'bitmap) still image files, and MP4 (MPEG-4 Part 14), AVI (Audio Video Interleave), MOV (Apple's Video Standard), MKV (High-Quality Video Container) and WebM (Optimized for the Web), for video files, as non-limiting examples.

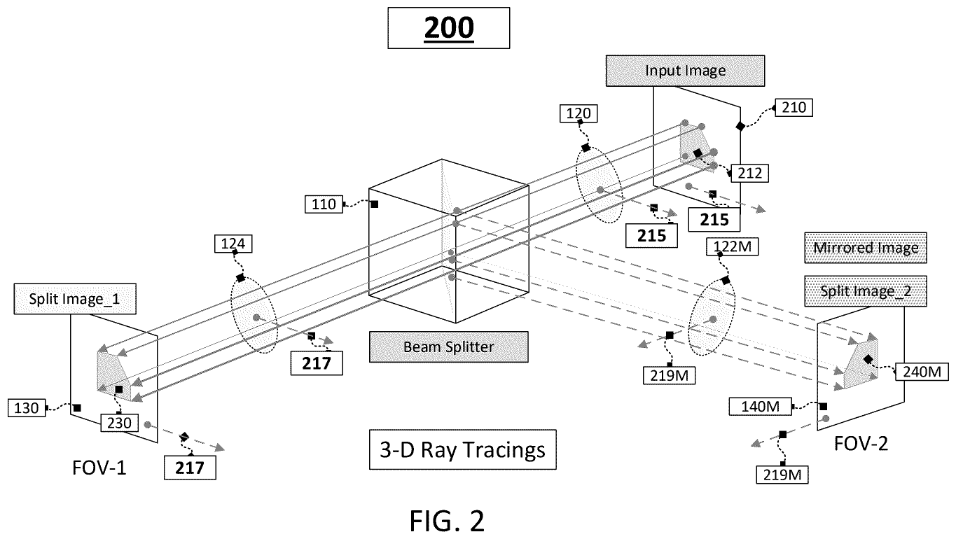

FIG. 2 provides a 3-dimensional view 200 of the single beam splitter 110 of the tileable array image sensor 100. Input image plane 210 with image 212 and horizontal direction vector 215 creates light rays 120. The beam splitter 110 creates light rays 124 with horizontal direction 217. Light rays 124 form image 230 on image plane 130 with horizontal direction vector 217. Beam splitter 110 also creates light rays 122M (mirrored image) and horizontal direction 219M (mirrored image). Light rays 122M form image 240M on image plane 140M with horizontal direction vector 219M.

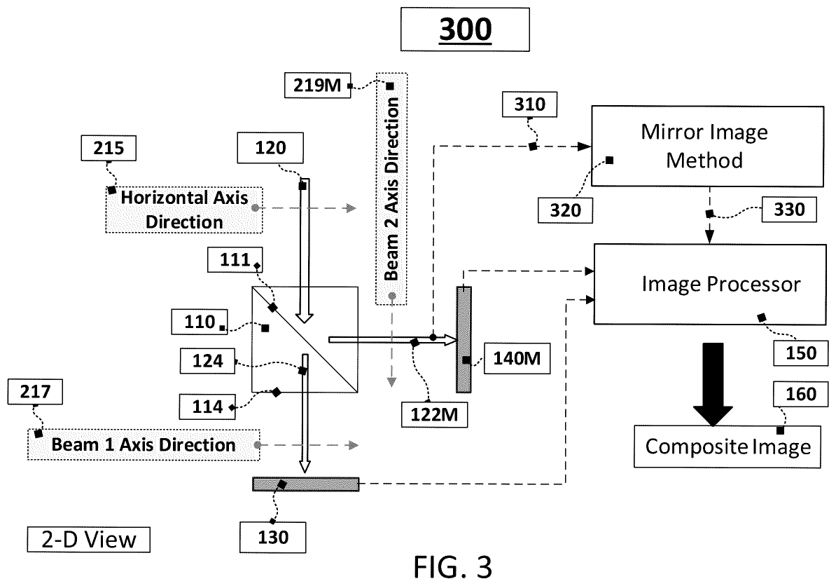

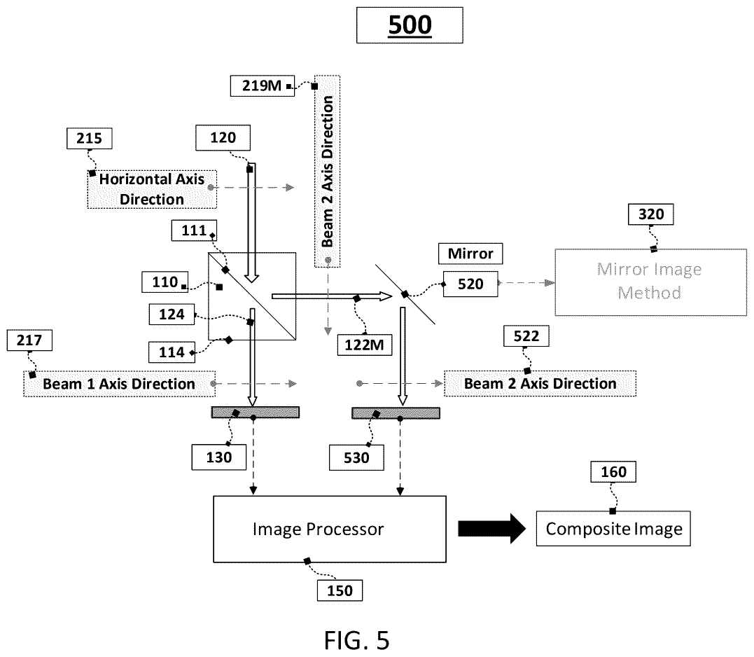

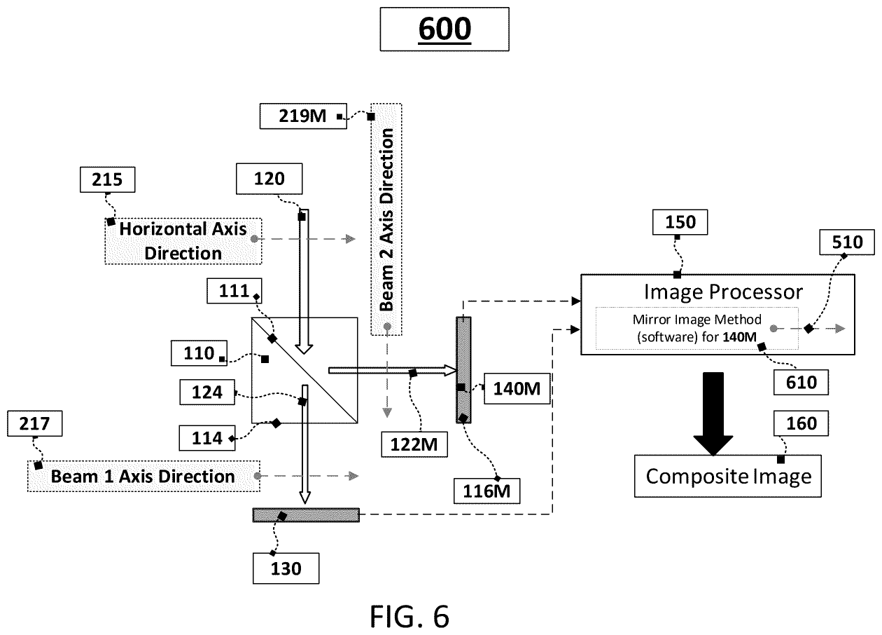

FIG. 3 presents a 2-dimensional view of a tileable array image sensor 300 in accordance with embodiments herein. Images from image sensor 130 and image sensor 140M are processed by image processor 150 to create composite image 160. As previously mentioned, the reflected beam 122M captured at image sensor 140M will be a mirrored image of the transmitted light 124 captured at image sensor 130. Thus, in accordance with embodiments of the invention, the mirrored images will need to be addressed. Thus, we present mirror imaging method(s) 320 to do so. In some embodiments, the mirror imaging method(s) 310 interfaces directly with and affects the reflected beam 122M prior to being captured by the image sensor 140M. This option is denoted as 310. The mirror imaging method(s) 320 may be a mirror (see FIG. 5). In other embodiments, the mirror imaging method(s) 320 interfaces processes the mirrored image captured by the image sensor 140M which is fed to the image processor 150. This option is denoted as 330. The mirror imaging method(s) 320 may be implemented via image processing which electronically/digitally mirrors the image (see FIG. 6).

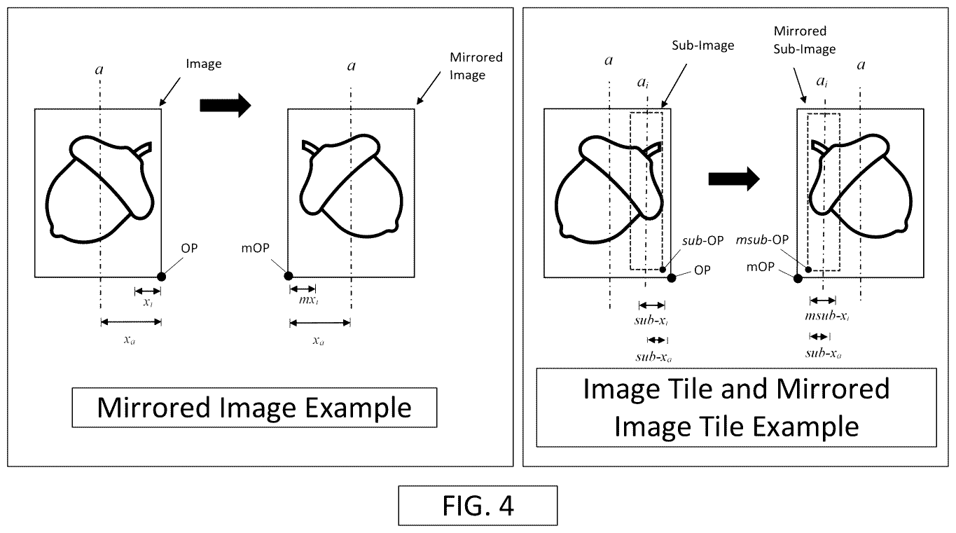

FIG. 4 illustrates how an image is mirrored. To “mirror,” the mirror (see FIG. 5) or mirroring method (see FIG. 6), “flips” or “reverses” the pixels of the image about an axis (typically, the mid-point vertical z-axis) as if the image is viewed in a mirror. Thus, pixels to the right become the pixels to the left and vice-versa in the mirrored image. Each of the second images from the second image sensors will need to be mirrored (or flipped) so that it will be in the same orientation as the first images from the first image sensors. Mirroring can be performed using an actual mirror or a digital mirroring algorithm. One exemplary digital mirroring algorithm of the type which could be used is available at: https://imageproedit.com/mirror-image-online.html; it is incorporated by reference in its entirety. The mirrored second images are essentially the same as the first images, and their positions are essentially the same.

As shown in the left image of FIG. 4, mirroring takes the image and flips into about a mirror axis. The mirror axis a is generally taken to be middle point of the field of view (FOV) in the horizontal or x-direction. Mirroring can be accomplished with a simple formula. In the horizontal or x-direction, we take the difference in distance from a given location point xᵢ to the mirror axis α, and either add it or subtract that value the distance xₐ to the mirror axis a as measured from the original point OP. This effectively flips the image in a symmetric manner about the mirror axis α to produce a mirrored image. This can be written as:

$$if {x}_{i} < {x}_{a} , then {x}_{m} = ( {x}_{a} - {x}_{i} ) + {x}_{a} , or \qquad ( 1 )$$

$$if {x}_{i} \geq {x}_{a} , then {x}_{m = (} {x}_{i} - {x}_{a} ) - {x}_{a}$$

The corresponding position in the vertical y-direction does not change; thus yₘ=y_{i . . .} (1a).

We denote the mirrored features with an m preceding the prior, corresponding element. This references the second sensor image array data to the new origin point mOP on the left side.

There is a symmetry between the original images and mirrored images. And the symmetry exists between sub-image(s) of the original images and mirrored sub-image(s). This is shown in the right image of FIG. 4.

We denote the origin position of a sub-image as sub-OP. We used the bottom left edge as one possibility. Its distance from the origin position OP of the FOV is determined by a sensor's placement in the second sensor array. The origin pointed of the mirrored sub-image msub-OP is determined using equations (1) and (1a). Knowing the origin position of the sub-image(s) sub-OP, the locations of the pixels in the sub-image sub-xᵢ can be mirrored about its own axis (midpoint) sub-x_{α}. Mirrored pixels in the sub-image msub-xₘ can be mirrored as follows:

$$if sub - {x}_{i} < sub - {x}_{a} , then msub - {x}_{m} = ( sub - {x}_{a} - sub - {x}_{i} ) + sub - {x}_{a} , or \qquad ( 2 )$$

$$if sub - {x}_{i} \geq sub - {x}_{a} , then msub - {x}_{m} = ( sub - {x}_{i} - sub - {x}_{a} ) - sub - {x}_{a} ,$$

The corresponding pixel positions in the vertical y-direction do not change; thus yₘ=yᵢ (2a).

This is repeated for all pixels in the sub-image. And the process is repeated for additional sub-images.

FIG. 5 illustrates a tileable array image sensor 500 in accordance with embodiments herein. It includes an optical mirror 520 (mirror method 320 in FIG. 3) to correct for the mirrored image from beam splitter 110. Mirror 520 may be a full reflective mirror element, position at a 45° angle. Horizontal axis 522 is parallel to horizontal axis 215 (input image). Images from the image sensors 130 and 530 are fed into image processor 150 to create composite image 160.

FIG. 6 illustrates a tileable array image sensor 600 in accordance with embodiments herein. Here, images captured by image sensors 130, 140M are sent to image processor 150. The images captured by images sensor 140M are mirrored with respect to the original light beam rays 120. Image processing method 150 mirrors image plane 140M using a mirror image method 610 to create an image with the horizontal direction 510 parallel to horizontal axis 215 from input image 212. Composite image 160 is created from images from the image sensor 130 and mirrored images from image sensor 140M.

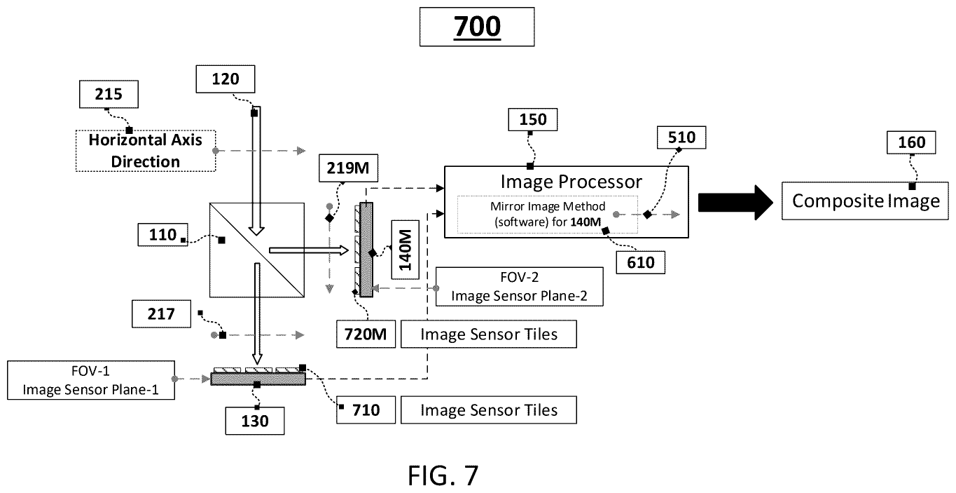

FIG. 7 illustrate a tileable array image sensor 700 in accordance with embodiments herein. It shows image sensor array 710 and mirrored image sensor array 720M for image sensors 130 and 140M, respectively. The images sensor may be an array of 3×1 image sensors, an array of 6×1 image sensors, or an array of 8×1 image sensors, for example. (More generically, we note the 1D image sensor arrays as an array of N×1 image sensors, where N is an integer greater than 1). Image processor 150 converts image tiles 710 and 720M to a composite image 160.

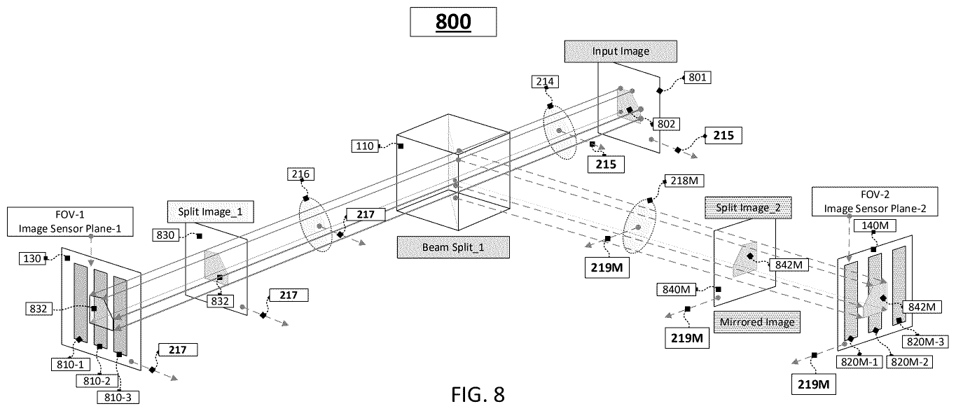

FIG. 8 shows a tileable array image sensor 800 in accordance with embodiments herein. It shows image sensor tiles 810-1, 810-2, and 810-3 on image FOV-1 plane 130 with horizontal direction vector 217. These are 3×1 image sensor arrays here. Rays 218M (M=mirrored) form image 842M on image sensor array 820M-1, 820M-2, and 830M-3 on FOV-2 image plane 140M.

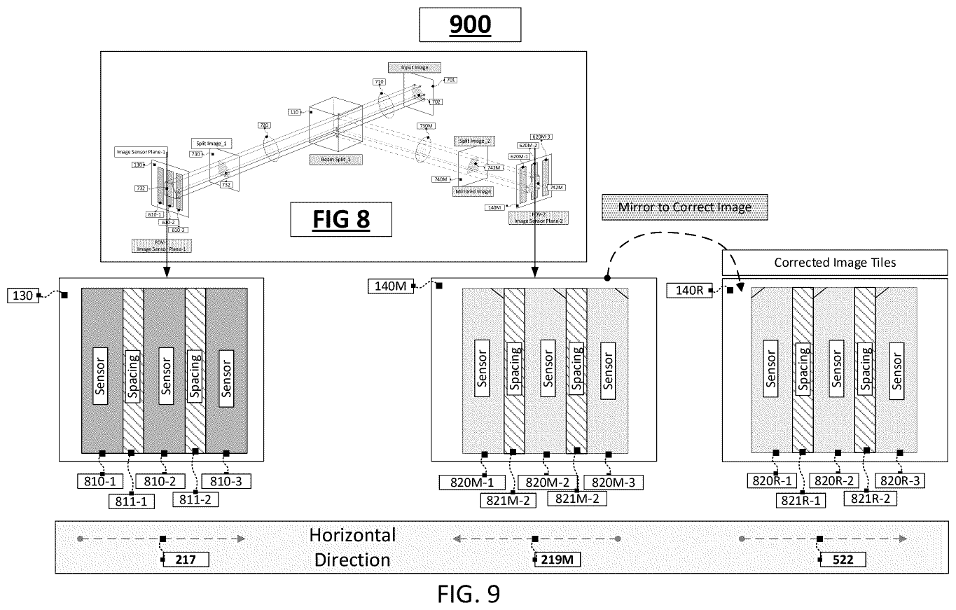

FIG. 9 shows more details of the image sensor tiles of FIG. 8. It shows rays 216 illuminating image sensor tiles 810 (810-1, 810-2, and 810-3). Spacings 811-1 and 811-2 are the gaps between sensor tiles 810. The figure also shows rays 218M illuminating image sensor tiles 820M (mirrored image) (820M-1, 820M-2, 820M-3). Spacings 821M-1 and 821M-2 are the gaps between sensor tiles 820M. Image tiles 820R apply a mirror image method to 820M to create image tiles (820R-1, 820R-2, 820R-3). Spacings 821R-1 and 821R-2 are the gaps between sensor tiles 820R. It will be appreciated that the positions of the image sensors in the second image sensor array, factoring in the effect of the mirror means, generally correspond to spaces between the adjacent image sensors in the first image sensor array in the first direction when their respective fields of view are superimposed and aligned.

To form the composite image 160, the positions of the second images are offset (or shifted) to essentially fill the spaces between the first images when factoring in the mirroring. In order to ensure continuous coverage, there may be some overlap between the edges of the shifted second images and the first images. This overlap, for instance, may be up to 20% overlap in spatial coverage between adjacent first and second images in the composite image. Higher overlap is possible; however, we believe the practical upper limit is about 10-20%.

FIG. 10 shows how image sensor array 1 (810) and image sensor array 2 (820R) overlap to create a composite image. The sensor arrays include three identical and spaced apart individual sensors (arranged in a horizontal direction). The sensors each have a length/height and a width t. The gap between adjacent sensors is a distance not exceeding the width t of the sensors. (If the sensors were oriented in the vertical direction, the distance s should not exceed the length of the sensors). If the gap equals the width of the sensor t, then there will be no overlap in the coverage of adjacent sensors. This option, however, does not provide much tolerance in coverage. On the other hand, if the gap is less than the width of the sensor t, then there will be a slight overlap in the coverage of adjacent first and second sensors to better absorb tolerances in coverage. We chose spacing between tiles to be 0.8 t, for instance. This provides a tile overlap of 0.1 t (10%). Total sensor width is 0.1 t (overlap)+0.8 t (gap)+0.1t (overlap)=1 t. Raw image is formed by stacking tiles 810 and 820R. Digital image stitching, position alignment corrections, angle corrections, and pixel intensity corrections are applied to the raw image to create a composite image 1020.

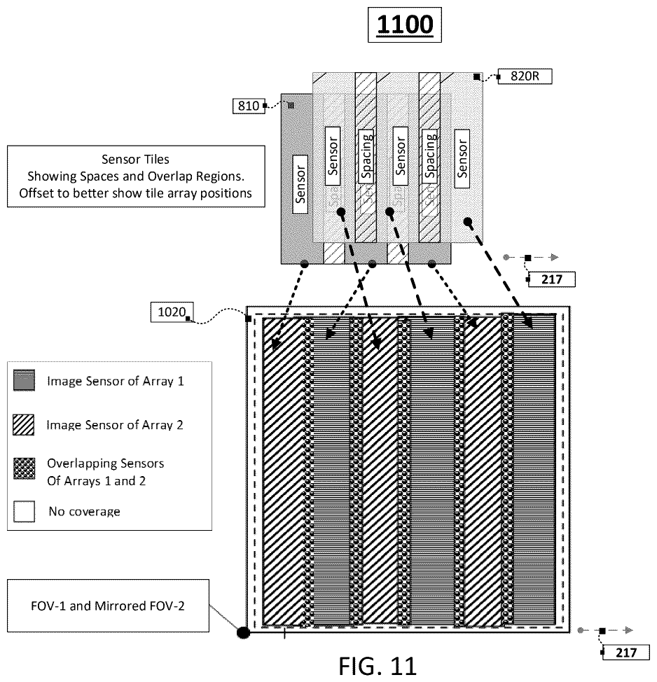

FIG. 11 illustrates stacking image tiles 810 and 820R. Gaps between image sensor tiles and overlapping sensor coverage are shown. Image tiles 810 and 820R completely cover the composite image 1020. There are no areas missing from the composite image 1020.

In designing the sensor arrays and positioning the sensors therein, we note that it may be easier backwards, that is, to work with mirrored data, to define the positions of the sensors in the first sensor image array and the mirrored second sensor image array. The positions of the sensors in the mirrored second image array should generally correspond to the position of gaps and/or spaces in the mirrored first image array. Depending on the design, the image sensor may (or may not) correspond to locations where there is no sensor coverage in the FOVs. From there, the mirrored second array data first and then be mirrored that to get the initial positioning data.

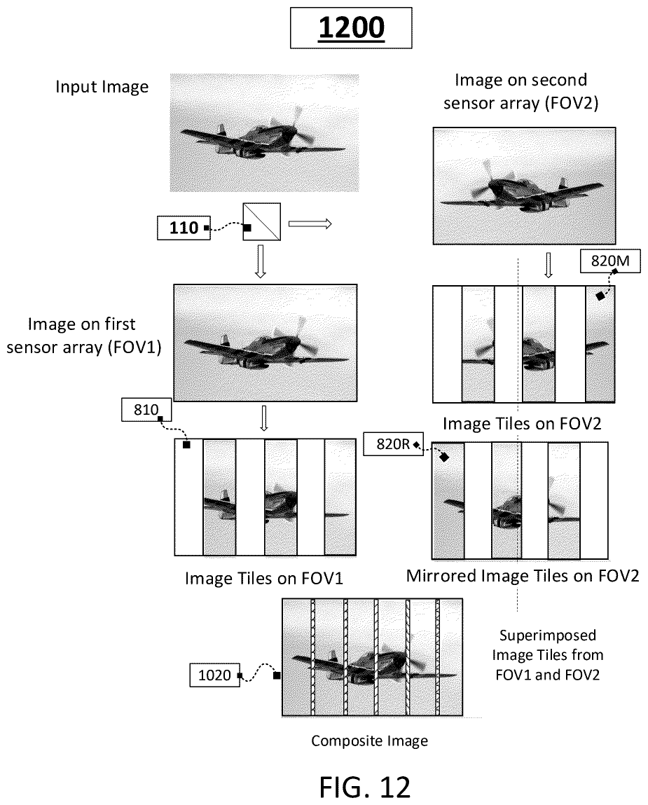

FIG. 12 shows an example of image tile processing using 3×1 image sensor arrays. The original image of an airplane enters the beam splitter 110, which generates transmitted image 810 and reflected image 820M that are captured by the Image Sensor Arrays, respectively. Since each image array sensor includes three (3) image sensors, the captured images each contain three (3) sub-images. The reflected image 820M is mirrored about the field of view of the image sensor to form mirrored image of 820R. Image tiles 810 and 820R are combine together to create composite image 1020. There is a slight overlap in the tiles of the composite image 1020 in this example with the design of the overlapping sensor array (see FIG. 11). But this need not always be the case.

The image processing steps, implemented by the image processor 150 to create the composite image 1020 in FIG. 12 are summarized in FIG. 13. We assume the implementation of the tileable array image sensor 600 which makes use of electronically/digitally mirroring means 610 to mirror the reflected image captured by image sensor 140M. In step 1, capture image tiles 810 and 820M (see FIG. 8). Image titles 820M are mirror images of image 810. (see FIG. 4). Next, in step 2, tiles 820M are mirrored about the field of view of the image sensor to create mirrored tile 820R (see FIG. 9). In step 3, tiles 810 and 820R are aligned to create the composite image (see FIGS. 10 and 11). And, in step 4, one or more optional image corrections may be applied. These include: 4a, removing undesirable internal reflection artifacts; 4b, and performing image alignment and/or rotation of image tiles; 4c, and applying pixel image intensity corrections.

When merging two sub-images any inconsistency along their border can be very visible. Various techniques to blend the overlapping regions have been developed to accomplish this. These can be applied in step 4a. Small geometric distortions must be harmonized across all sub-images, correcting for perspective, skew, etc. imaging a large photograph, cut into rectangular pieces. These sub-images are then scattered across an uneven surface. First, all sub-images must be tiled so that they lay on a single flat surface. Following that, they can be rotated and shifted until their edges line up in step 4b. Lighting must be even across all the composite image, especially at the edges. When two sub-images meet at a border, a small inequality in brightness can cause the border to be highly visible. Thus, in step 4c, the brightness must be reconcile. For instance, the overlapping pixels intensity may be halved. Sub-image color correction, commonly known, might also be applied too in an analogous manner.

Finally, in step 5, the processed image tiles are stitched together to create the composite image 160. Once the imaging device is fully assembled, its shape and the geometry of the sensory arrays is fixed. When stitching images, one of the early steps is to determine the factors which allow geometric corrections to be made. With a fixed geometry, many of these factors can be calculated at the time of manufacture, and stored for the user. This would eliminate a large part of the computational task every time the user stitches a mosaic. Many image stitching techniques are available which can be used here. See, e.g., M. Fu et al., “Image Stitching Techniques Applied to Plane or 3-D Models: A Review,” in IEEE Sensors Journal, vol. 23, no. 8, pp. 8060-8079, 15 Apr. 2023, doi: 10.1109/JSEN.2023.3251661, herein incorporated by reference in its entirety.

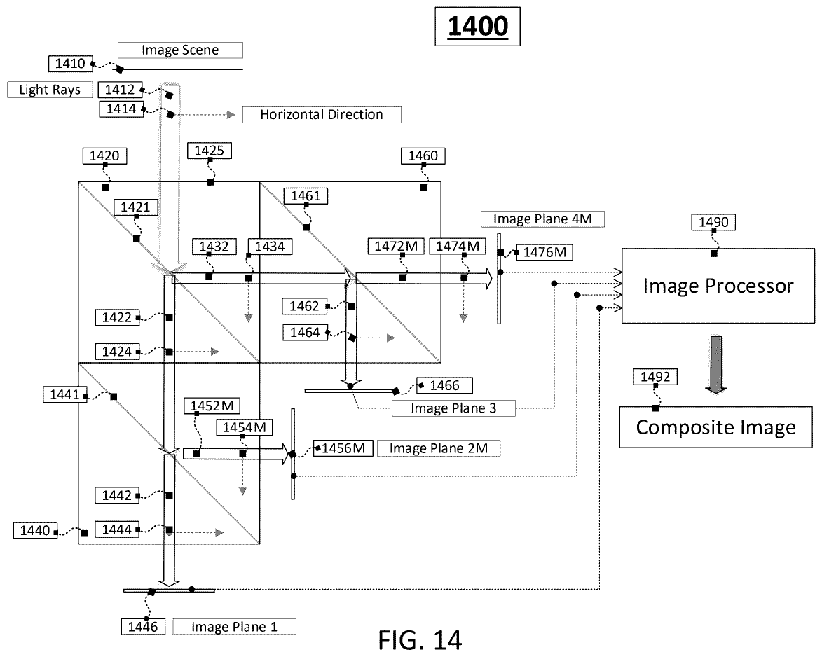

The aforementioned techniques may be expanded to a second dimension. FIG. 14 shows a tileable array image sensor 1400 in accordance with embodiments of the present invention. It makes use of three beam splitters which create four copies of the input image. The beam splitters reduce the image intensity to ¼ the input image's intensity. The images sensors may be a 2D array of 3×3 image sensors, an array of 6×6 image sensors, or an array of 8×8 image sensors, for example. (More generically, we note the 2D image sensor arrays as an array of M×N image sensors, where M and N are integers both greater than 1).

Input image scene 1410 creates light rays 1412 with horizontal direction vector 1414. Light rays 1412 enter beam splitter 1420 at surface 1425. Beam splitter half silvered plane 1421 creates light rays 1432 with direction vector 1434 and light rays 1422 have horizontal direction 1424. Beam splitter 1440 with half silvered plane 1441 creates light rays 1452M with direction vector 1454M and light rays 1442 with direction vector 1444. Light rays 1444 form image 1446 (image plane 1). Light rays 1452M form image 1456M on image plane 2M (mirrored image). Beam splitter 1460 splits light rays 1432 into light rays 1462 with direction vector 1464 and light rays 1472M with direction vector 1474M. Light rays 1462 create image plane 3 (1466). Light rays 1472M form image plane 4M (mirrored image) 1474M. Image planes 1446, 1456M, 1466, and 1476M are processed by image processor 1490 to create a composite image 1492.

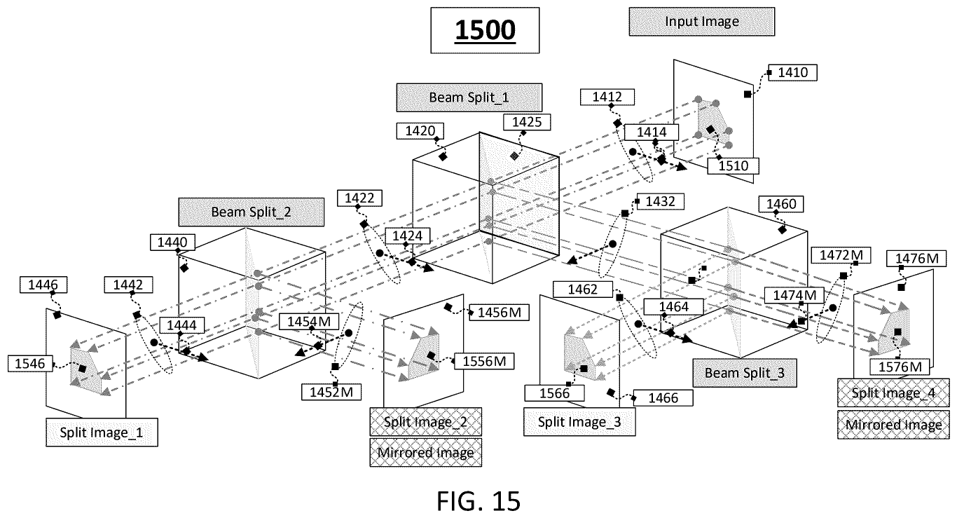

An exploded 3-dimensional view 1500 of the tileable array image sensor having three beam splitters is presented in FIG. 15. Input image plane 1410 creates image 1510 forming light rays 1412 with direction vector 1414. Light rays 1442 form image 1546 on image plane 1 (1446). Light rays 1452M with direction 1454M form image plane 2 (1456M) image 1556M (mirrored image). Light rays 1462 with direction 1464 form image 1566 on image plane 1466 (image plane 3). Light rays 1472M with direction 1474M form image 1576M on image plane 1476M (image plane 4M).

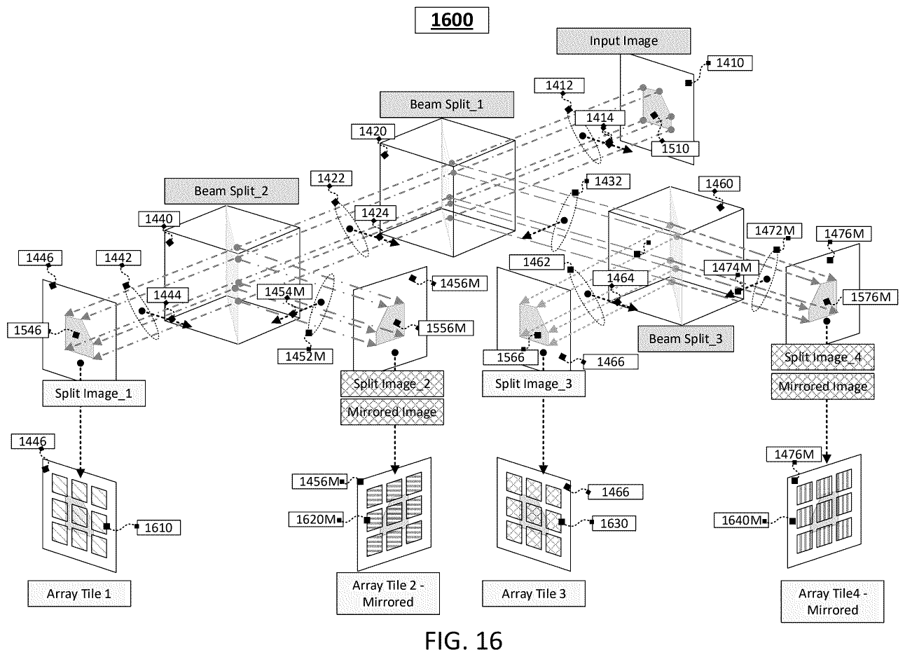

FIG. 16 shows a tileable array image sensor 1600 in accordance with embodiments of the present invention. Here, we use 3×3 image array sensors to produce image sensor tiles 1 (1610), image sensor tiles 2 (1620M), image sensor tiles 3 (1630), and image sensor tiles 1640M. Image 1546 is captured by image sensor tiles 1 (1610). Image 1556M is captured by image sensor tiles 2 (1620M). Image 1566 is captured by image sensor tiles 3 (1630). Image 1576M is captured by image sensor tiles 4 (1640M). For FIG. 16 “M” shows a mirrored image.

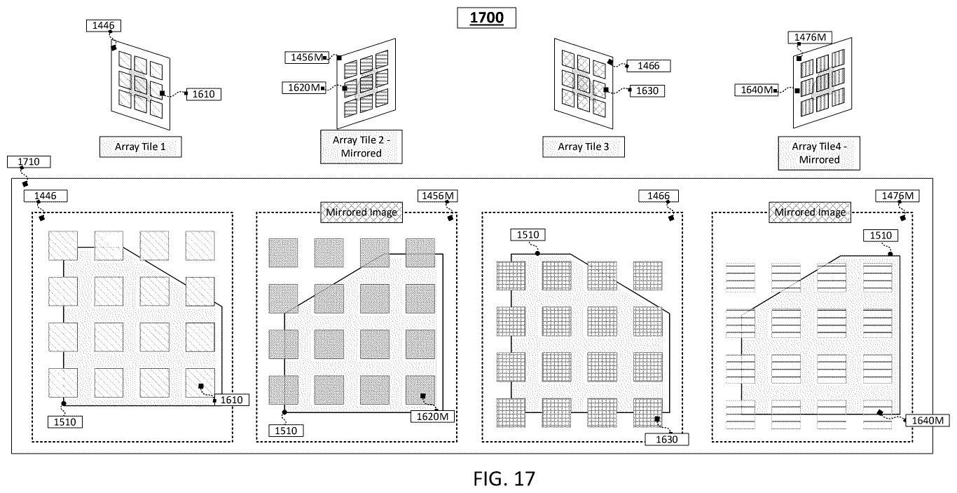

In FIG. 17, we show an overview 1700 of the images captured by the image array sensors using the tileable array image sensor 1600 of FIG. 16. It shows image tiles 1610 (image array 1), 1620M (image array 2M), 1630 (image array 3), and 1640M (image array 4m) form image array set 1710. Input image 1510 is shown behind the sensor arrays to indicate the position and direction vector for the sensed image 1510. Image sensor arrays ending in “M” capture mirrored images.

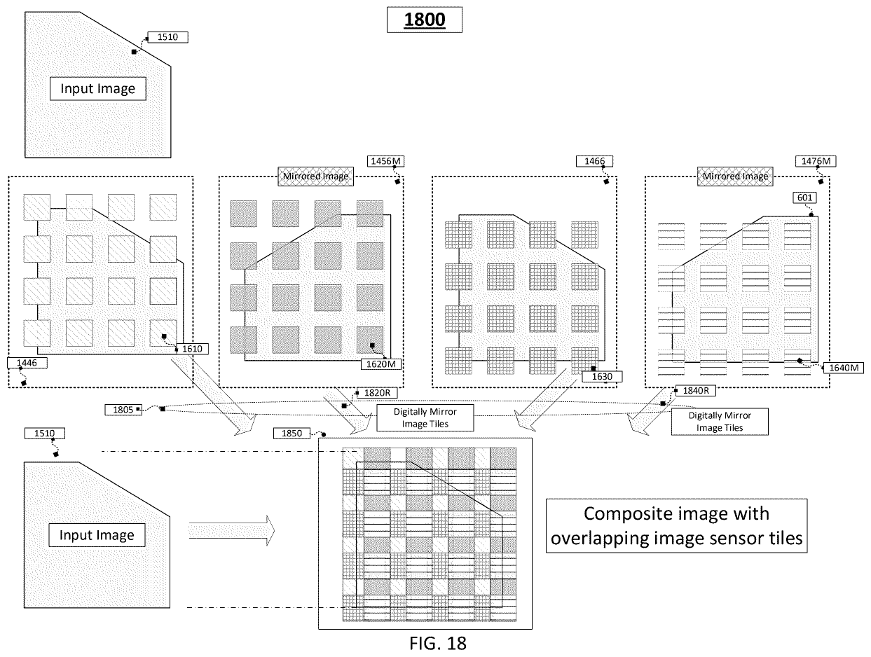

FIG. 18 shows a tileable array image sensor 1800 in accordance with embodiments of the present invention. It shows the sensor tiles and relative positions for the image plane 1 (1446), image plane 2M (1456M), image plane 3 (1466) and image plane 4M (1476M). The sensor tiles (1610, 1820R, 1630, and 1840R) form an overlapping composite image in 1860. Sensor tiles 1620M are mirrored to create 1820R. Sensor tiles 1640M are mirrored to create 1840R. Thereby, removing the mirror image from the beam splitters.

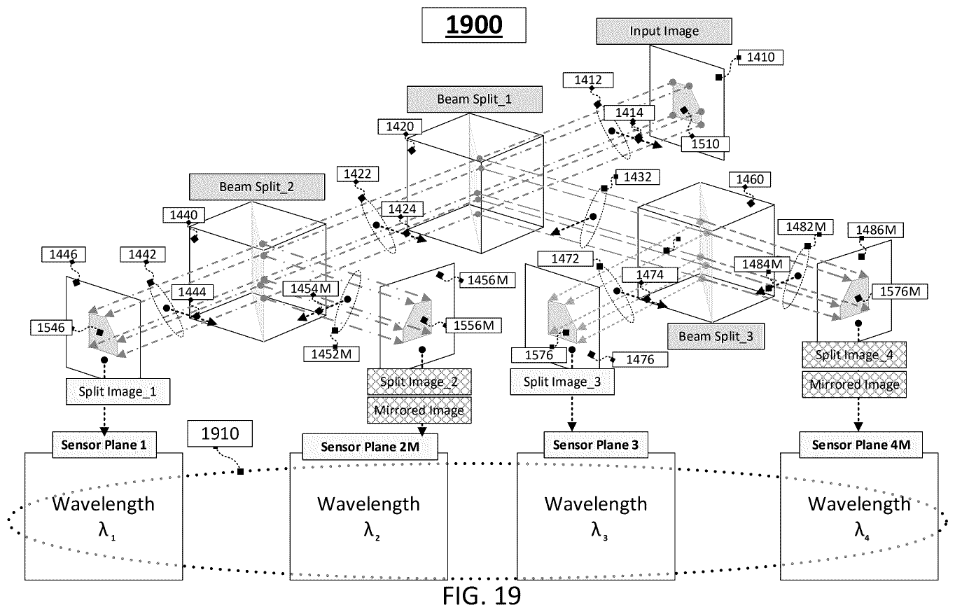

FIG. 19 illustrates a tileable array image sensor 1900 in accordance with embodiments of the present invention. Here, each sensor plane 1910 is being used to detect a different optical wavelength. High resolution IR, mid-IR, long-IR and/or THz image seen could be generated using the present invention. Each sensor tile (1610, 1620M, 1630, and 1640M) can use a different optical wavelength filter to create a hyperspectral imaging system. This could be achieved with the one-dimensional embodiments too. Each sensor tile can also have an individual wavelength filter to create a larger hyperspectral imaging array.

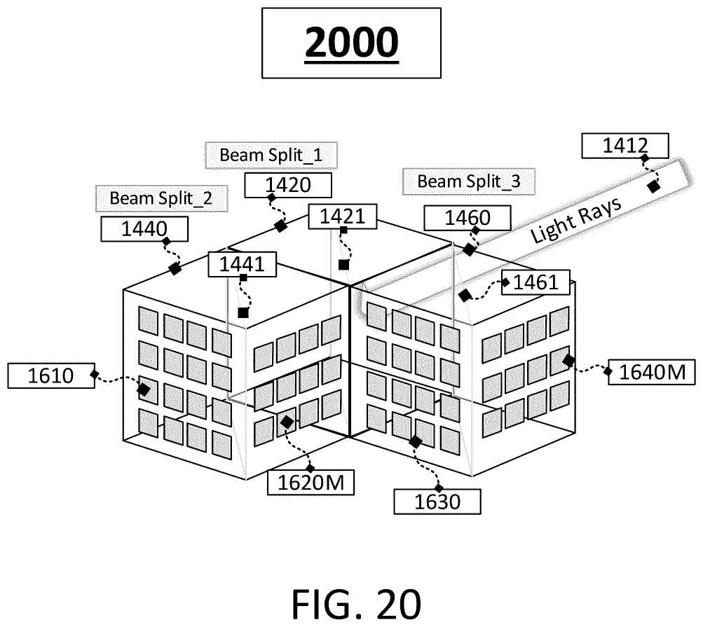

FIG. 20 shows a tileable array image sensor 2000 in accordance with embodiments of the present invention. It shows the relative positions of the sensor tiles (1610, 1620M, 1630, and 1640M) on the 3-beam splitter assembly 2000. The image sensors are mounted on and/or integrated into a printed circuit board to form the image sensor arrays which is mounted adjacent to the beam splitters. Or the image sensors may simply be attached to the beam splitters using an optical grade glue, for example.

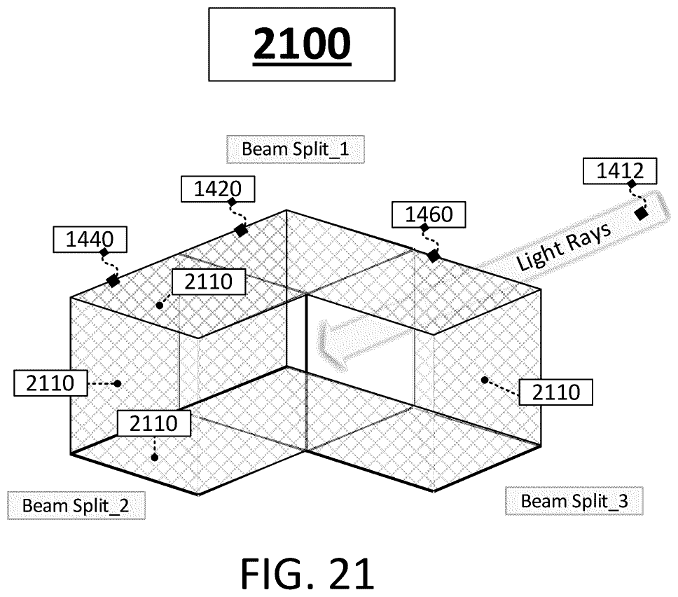

FIG. 21 shows a tileable array image sensor 2100 in accordance with embodiments of the present invention. It includes three beam splitters 1420, 1440 and 1460. The output surfaces 2110 of beam splitters 1420, 1440 and 1460 have anti-reflection coatings and optical baffles to reduce unwanted internal reflections (image ghosting).

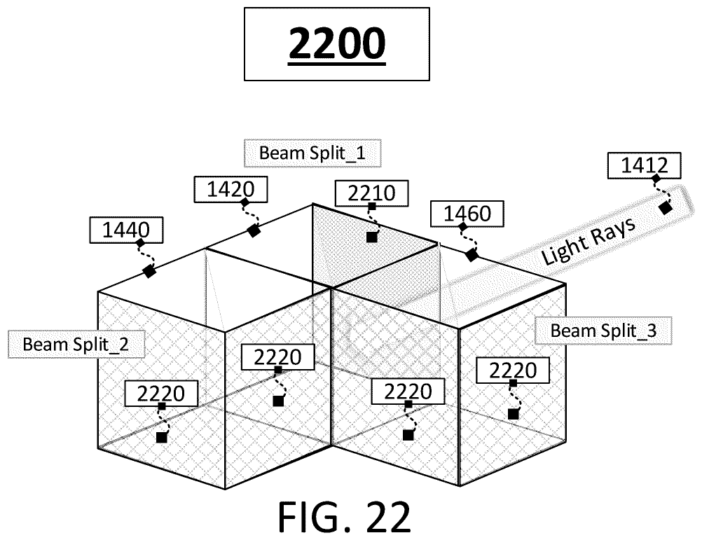

FIG. 22 shows a tileable array image sensor 2200 in accordance with embodiments of the present invention. It includes anti-reflection coatings and optical baffles 2220 for the image planes (1610, 1620M, 1630, and 1640M). Beam splitter 1 (1420)'s light input surface 2210 has an anti-reflection coating and optical baffle to reduce unwanted reflections.

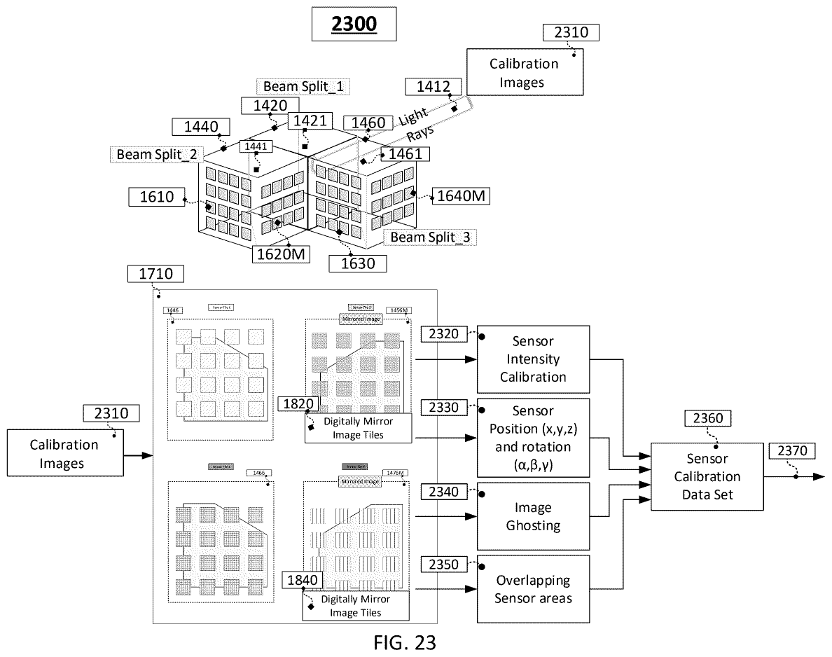

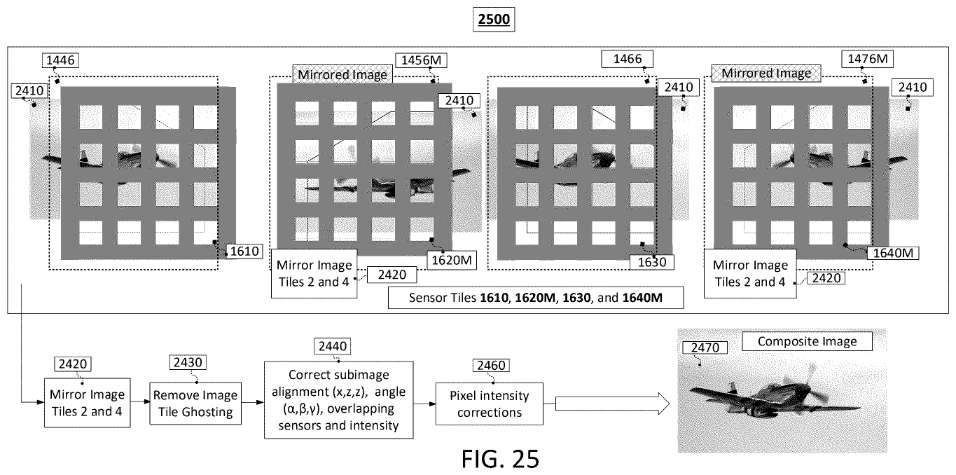

FIG. 23 shows the sensor calibration sets 2300 according to embodiments. A calibration image set 2310 is used to create sensor calibration 2360 data set 2370: (1) sensor intensity calibration data 2320; (2) sensor position (x, y, z) calibration, and rotation (α, β, γ) calibration data 2330; (3) image ghosting calibration data 2340; and overlapping sensor data calibration 2350. Optical assembly 1500 is a rigid structure and is long term stabile. Calibration data can be created during manufacturing of 1500 and stored (e.g., in a memory associated with the processor 150) to help improve the accuracy and speed up the image stitching process. Rigid structure 1500 and calibration data 2370 help simplify image stitching algorithms to combine the sensor tiles into a composite image 1492. Sensor calibration data set 2300 provides optimizations to speed up and simplify image mosaic tile stitching in FIG. 25. Or re-calibration may be performed at regular intervals and/or should it become necessary.

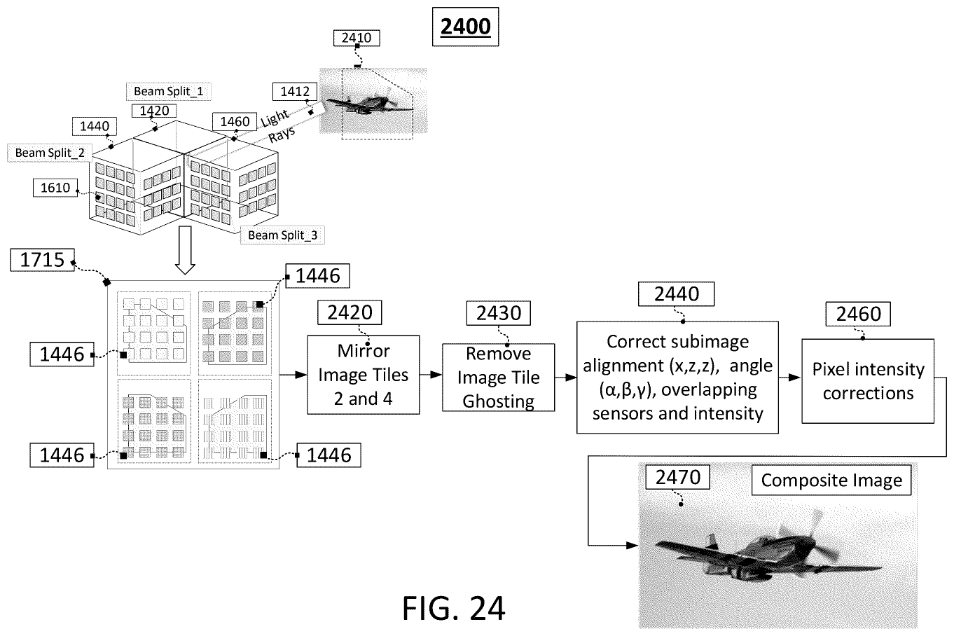

FIG. 24 summarizes the steps for an image capture method 2400 according to embodiments. The image processing steps 2400 convert the image tiles (1610, 1620M, 1630, and 1640M) into a composite image 2470. Input image 2410 is fed into the present invention 1500 and four sensor arrays create image tiles (1610, 1620M, 1630, and 1640M). Image processing steps 2400 utilize the calibration data sets from 2300. Image processing step 2420 corrects the mirrored image from 1620M and 1640M. Image processing step 2430 removes image ghosting. Image processing step 2440 corrections for position and rotation alignment errors. Image processing step 2460 applies pixel intensity corrections 2460. A standard image stitching technique is applied in 2470 to create a high resolution (1 gigapixel or greater, smaller is also possible) composite image 2470. For example, see the 2023 M. Fu et al., IEEE Sensors Journal article mentioned above. While the steps in 2400 are shown as sequential, it should be appreciated that they may also be processed in parallel.

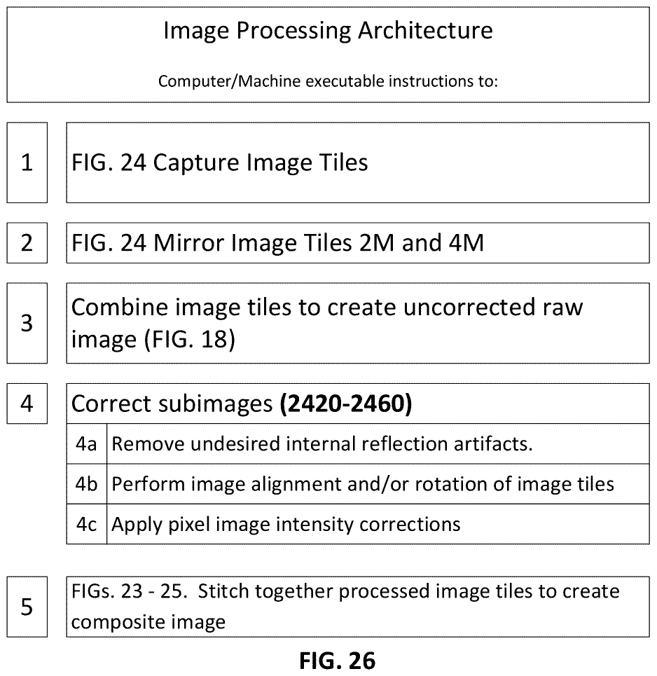

FIG. 25 shows an example image converted to image sensor tiles (1446, 1456M, 1466 and 1476M) and digitally processed (2400) to create a composite image 2470. FIG. 26 summarizes the algorithm used in FIG. 24 and FIG. 25 to create a composite image. It is essentially like the algorithm shown in FIG. 13, just applying processing in two dimensions.

Where conditional language is used, including, but not limited to, “can,” “could,” “may” or “might,” it should be understood that the associated features or elements are not required. As such, where conditional language is used, the elements and/or features should be understood as being optionally present in at least some examples, and not necessarily conditioned upon anything, unless otherwise specified.

Where lists are enumerated in the alternative or conjunctive (e.g. one or more of A, B, and/or C), unless stated otherwise, it is understood to include one or more of each element, including any one or more combinations of any number of the enumerated elements (e.g. A, AB, AC, ABC, ABB, etc.). When “and/or” is used, it should be understood that the elements may be joined in the alternative or conjunctive.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, and to describe the actual partial implementation in the laboratory of the system which was assembled using a combination of existing equipment and equipment that could be readily obtained by the inventors, to thereby enable others skilled in the art to best utilize the invention and various embodiments with various modifications as may be suited to the particular use contemplated.

While the foregoing is directed to embodiments of the present invention, other and further embodiments of the invention may be devised without departing from the basic scope thereof, and the scope thereof is determined by the claims that follow.

1. A tileable array image sensor comprising:
a first beam splitter, which receives light, and transmits a portion of that light and reflects a portion of that light from first and second surfaces thereof, respectively;
a first image sensor array of image sensors spaced-apart in a first direction having a first field of view positioned near the first surface of the first beam splitter, to receive the transmitted light from the beam splitter, and to generate a first set of images;
a second image sensor array of image sensors spaced-apart in the first direction having a second field of view positioned near the second surface of the beam splitter, to receive the reflected light from the first beam splitter, and to generate a second set of images;
a mirror means to mirror light to, or digitally mirror the second set of images with respect to, the second field of view of the second image sensor array,
wherein positions of the image sensors in the second image sensor array, factoring in the effect of the mirror means, generally correspond to spaces between the adjacent image sensors in the first image sensor array in the first direction when their respective fields of view are superimposed and aligned; and
an image processor configured to:
obtain first and second sets of images from the first and second image sensor arrays, respectively;
align and superimpose the first set of images and the second set of images factoring in the effect of the mirror means; and
combine the aligned superimposed images to generate a composite image.

2. The sensor of claim 1, wherein the sensor is a one-dimensional tileable array image sensor.

3. The sensor of claim 2, wherein the first and second image sensor arrays each comprise:
an array of N×1 image sensors, where N is an integer greater than 1.

4. The sensor of claim 1, wherein, for each of first and second image sensor arrays, the image sensors are identical and spaced apart in the first direction by a distance not exceeding a length/width of the image sensors in the first direction.

5. The sensor of claim 1, wherein there is up to 20% overlap in the superimposed positions of image sensors in the first image sensor array and adjacent positions of the image sensors in the second image sensor array in the first direction. Higher overlap is possible; however, there is a practical upper limit.

6. The sensor of claim 1, wherein the mirror means comprises (i) a mirror positioned between the second surface of the beam splitter and the second image sensor array to reflect the reflected light from the first beam splitter to the second field of view of the second image sensor array, or (ii) a processing technique to digitally mirror the images from the image sensors of the second image sensor array with respect to the second field of view.

7. The sensor of claim 1, wherein the sensor is a two-dimensional tileable array image sensor.

8. The sensor of claim 7, wherein the first, second, third and fourth image sensor arrays each comprise: an array of M×N image sensors, where M and N are integers both greater than 1.

9. The sensor of claim 7, further comprising:
a pair of second beam splitters positioned near the first and second surfaces of the first beam splitter, which receives the transmitted and reflected portions of light, respectively, from the first beam splitter, and each of the pair further transmits and reflects second portions of light from first and second surfaces thereof, respectively,
wherein the image sensors of the first and second image sensor arrays are spaced-apart in the first direction and a second direction, perpendicular to the first direction, to receive transmitted and reflected second portions of light from the first of the pair of second beam splitters, respectively, and to generate the first and second sets of images;
third and fourth image sensor arrays of image sensors spaced-apart in the first direction and the second direction, having third and fourth field of views, respectively, positioned near surfaces of the second of the pair of the second beam splitters, to receive the transmitted and reflected second portions of light from the second of the pair of second beam splitters, respectively, and to generate third and fourth sets of images,
wherein the mirror means also mirrors light to, or digitally mirror the fourth set of images with respect to, the fourth field of view of the second image sensor array;
wherein positions of the image sensors in the second image sensor array, factoring in the effect of the mirror means, generally correspond to spaces between the adjacent image sensors in the first image sensor array in the first and second directions when their respective fields of view are superimposed and aligned;
wherein positions of the image sensors in the fourth image sensor array, factoring in the effect of the mirror means, generally correspond to spaces between the adjacent image sensors in the third image sensor array in the first and second directions when their respective fields of view are superimposed and aligned;
wherein positions of the image sensors in the second image sensor array, factoring in the effect of the mirror means, generally correspond to spaces between the adjacent image sensors in the first image sensor array in the first and second directions when their respective fields of view are superimposed and aligned;
wherein the positions of the image sensors in the third and fourth image sensor arrays in the second direction, factoring in the effect of the mirror means, generally correspond to spaces between the adjacent image sensors in the first and second image sensor arrays in the first and second directions, respectively, when their respective fields of view are superimposed and aligned; and
the image processor configured to:
obtain first, second, third and fourth sets of images from the first, second, third and fourth image sensor arrays, respectively;
align and superimpose first, second, third and fourth sets of images factoring in the effects of the mirror means; and
combine the superimposed images to generate the composite image.

10. The sensor of claim 9, wherein the mirroring means comprises: (i) a first mirror positioned between the second surface of the first of the pair of the second beam splitter and the second image sensor array to reflect the reflected light from the first of the pair of the beam splitters to the second field of view of the second image sensor array; and a second mirror positioned between the second surface of the second of the pair of the second beam splitter and the fourth image sensor array to reflect the reflected light from the second of the pair of the beam splitters to the fourth field of view of the fourth image sensor array; or (ii) a processing technique to digitally mirror the second and fourths set of images about the second and fourth fields of view, respectively.

11. The sensor of claim 1, wherein the image processor is configured to perform an image stitching technique to combine the digitally superimposed images to generate the composite image.

12. The sensor of claim 1, wherein the image sensors are mounted on and/or integrated into a printed circuit board to form the image sensor arrays.

13. The sensor of claim 1, wherein, in each of image sensor arrays, the sensors are configured to image light of different spectra.

14. The sensor of claim 1, further comprising optics for focusing, collimating, and/or filtering light into the beam splitter.

15. A method for image tiling using the tileable array image sensor of claim 1, the method
comprising:
obtaining first and second sets of images from the first and second image sensor arrays, respectively;
aligning and superimposing first, second, third and fourth sets of images factoring in the effects of the mirror means; and
combining the aligned and superimposed images to generate a composite image.

16. The method of claim 15, wherein generating a composite image comprises: performing an image stitching technique on the aligned images.

17. The method of claim 15, further comprising: performing one or more of (i) removing undesired internal reflection artifacts from the captured first and second sets of images;
(ii) correcting sub-image image alignment and/or angle in the that the captured first and second sets of images; and (iii) applying pixel intensity correction to the captured first and second sets of images.

18. The method of claim 15, comprising:
obtaining first, second, third and fourth sets of images from the first, second, third and fourth image sensor arrays, respectively;
aligning and superimposing first, second, third and fourth sets of images factoring in the effects of the mirror means; and
combining the aligned and superimposed images to generate the composite image.

19. A method for calibrating the using the tileable array image sensor of claim 1, the method comprising:
performing sensor intensity calibration; and
outputting sensor calibration data set for tileable array image sensor.

20. The method of claim 19, further comprising:
configuring the sensor with the output sensor calibration data.
